(19) United States
(12) Patent Application Publication
(10) Pub. No.: US 2023/0256323 A1
(43) Pub. Date: Aug. 17, 2023

(54) BIBLE LESSONS AND SCRIPTURES LEARNING GAME AND METHODS OF PLAYING BIBLE GAMES

(71) Applicant: Ernestine Barnett, Peoria, IL (US)

(72) Inventor: Ernestine Barnett, Peoria, IL (US)

(21) Appl. No.: 17/884,938

(22) Filed: Aug. 10, 2022

Related U.S. Application Data
(60) Provisional application No. 63/311,236, filed on Feb. 17, 2022.

(51) Int. Cl. A63F 3/00; A63F 1/02; G09B 19/00

(52) U.S. Cl. CPC A63F 3/001; A63F 1/02; G09B 19/00

(57) ABSTRACT

The present invention relates to a charade-based Bible game system for improving knowledge about the Bible and lessons of the Bible. The game system can be played by children and adults as individuals or as teams. The game system allows players to play a plurality of games for learning about the Bible and includes a plurality of cards that have scripture printed thereon. Some embodiments include mix and match games allowing players to win games when matched cards are collected by players. Matched cards may have Jesus titles, Lucifer titles, and princess/queens names. Other embodiments may have scrambled words which are unscrambled by players within a time limit set by a timer for winning the games. The game system offers a way for individuals to have fun with friends and family while still being educated on the Bible and its lessons.

### CROSS-REFERENCE TO RELATED APPLICATION

The present application claims priority to, and the benefit of, U.S. Provisional Application No. 63/311,236, which was filed on Feb. 17, 2022 and is incorporated herein by reference in its entirety.

### FIELD OF THE INVENTION

The present invention relates generally to the field of Bible games. More specifically, the present invention relates to a charades-based game involving Bible scriptures and lessons, wherein said scriptures and lessons can be acted out with alternate endings. The game includes cards that have scriptures and life lessons printed thereon, chips used for scoring, masks indicating learnings taught during the game, sand timer for calculating time for playing the game, magnetic millets, and more. The game has multiple versions wherein each version intends to give an understanding about the Bible. The games can be played by individual members or by teams. Accordingly, the present disclosure makes specific reference thereto the present invention. Nonetheless, it is to be appreciated that aspects of the present invention are also equally applicable to other like applications, devices, and methods of manufacture.

### BACKGROUND

By way of background, individuals use different games, such as board games, bingo games, electronic games, and more, for fun and entertainment. Numerous games have been provided in prior art that are adapted to utilize chance determining means for playing and winning the game. Entertainment is provided to the players by challenging them, so that they utilize their skill and acumen in playing the game. Conventional games, in addition to fun and entertainment, provide learning and education. Games like puzzles, arcade games, and more are also useful for brain stimulation and help in alleviating mental fatigue. Charade games are more interactive and require individuals to learn and act, allowing them to have fun while enacting and asking questions.

Generally, religious individuals preach about God, religions, scriptures, and their learnings to introduce and make individuals aware about religion. Individuals acknowledge the fact that learning about religions and religious scriptures is important to their personal growth, however, some individuals do not engage in learning from the conventional method of speeches by religious individuals. Therefore, individuals desire a more engaging way of introducing Bible and other religious scriptures and themes. Individuals desire a way to introduce Bible scriptures and themes to the gameplay allowing individuals to have fun and to be entertained while still being educated on the Bible.

Therefore, there exists a long-felt need in the art for a unique game that helps improve knowledge about the Bible and scriptures. There is also a long-felt need in the art for a game system that allows players to answer questions or act out scripture and lessons to play a game and learn about the Bible. Additionally, there is a long-felt need in the art for a game system that is designed to provide fun while testing one's knowledge of the Bible and learning as the game is played. Moreover, there is a long-felt need in the art for a game that is designed to be an interactive multi-player game which includes scripture cards, playing chips, timer, instruction cards, and more. Further, there is a long-felt need in the art for a game that includes a software application for teaching about Bible scripture and lessons. Furthermore, there is a long-felt need in the art for a Bible game that allows individuals to play a variety of games to learn about the Bible. Finally, there is a long-felt need in the art for a unique charades-based game involving Bible scripture and lessons that offers a way for individuals to have fun with friends and family while still being educated on the Bible.

The subject matter disclosed and claimed herein, in one embodiment thereof, comprises a charade-based Bible game system. The game system, further comprising a set of 300 cards, each card having at least a scripture and a scrambled life lesson printed thereon; a set of 20 masks, each mask represents a teaching of the Bible and is configured to be worn by a player playing the game system; a sand-timer for calculating time, wherein the sand-timer is flipped when a player starts his/her turn; a set of red chips; a set of yellow chips, wherein the yellow chips provide extra playing time; a set of black chips, wherein the black chips are given to a player upon providing an incorrect answer; and, a software application for displaying scripture and lessons learned while using the game system.

In this manner, the game system of the present invention accomplishes all of the foregoing objectives and provides users with a unique, charades-based game involving Bible scripture and lessons. The game can be played by children and adults and is designed to improve knowledge about the Bible and its lessons. The system allows individuals to use a plurality of games to learn about various Bible lessons or teachings. The game system offers a way for individuals to have fun with friends and family while still being educated on the Bible.

### SUMMARY OF THE INVENTION

The following presents a simplified summary in order to provide a basic understanding of some aspects of the disclosed innovation. This summary is not an extensive overview, and it is not intended to identify key/critical elements or to delineate the scope thereof. Its sole purpose is to present some general concepts in a simplified form as a prelude to the more detailed description that is presented later.

The subject matter disclosed and claimed herein, in one embodiment thereof, comprises a charade-based Bible game system. The game system further comprises a set of 300 cards, each card having at least a scripture and a life lesson printed thereon; a set of 20 masks, each mask represents a learning or teaching of the Bible and is configured to be worn by a player playing game system; a sand-timer for calculating time, wherein the sand-timer is flipped when a player starts his/her turn; a set of red chips; a set of yellow chips, wherein the yellow chips provide extra playing time; a set of black chips, wherein the black chips are given to a player upon providing an incorrect answer; and, a software application for displaying scripture and lessons learned or taught while using the game system.

In yet another embodiment, a method of playing a Bible game is described. The method includes the steps of providing a plurality of playing cards; providing a plurality of masks; providing a plurality of red chips; providing a plurality of black chips; providing a plurality of yellow chips; providing a sand timer; providing learning books; mixing the playing cards and placing them face down; picking up two cards by a player and turning said cards over; collecting the cards by a player if the card matches or else placing the cards facing down in their original position; and, continuing game play by having another player pick up two cards.

In yet another embodiment, the cards picked up by a player match when one of the following occurs: (a) both cards have the Bible queens or princess names; (b) both the cards have the Bible Jesus titles and names; (c) both the cards have Lucifer titles and names; and, (d) both the cards have a fruit or gift of the Spirit printed thereon.

In yet another embodiment, a method of playing a Bible game for learning God's promises is disclosed. The method includes providing a magnet board, providing a set of 80 magnet pellets, providing four dry erase markers, providing an answer key, providing a sand timer, providing a set of 300 cards, providing a plurality of score boards, providing one book of sticky paper, providing a set of 50 black chips, providing a set of 50 red chips and providing a set of 50 yellow chips; picking up a card by a host; reading out, by the host, a scrambled word printed on the card and simultaneously starting a sand-timer; unscrambling, the scrambled word, by a plurality of teams playing the game; providing a black chip equivalent to 50 points to one or more teams correctly unscrambling the word within the time set by the sand timer; reading out, by the host, a scripture when any of the teams do not unscramble the scrambled word; providing a yellow chip equivalent to 25 points to one or more teams correctly unscrambling the word within the time set by the sand timer; reading out, by the host, a second scripture when any of the teams do not unscramble the scrambled word; and providing a red chip equivalent to 15 points to one or more teams correctly unscrambling the word within the time set by the sand timer, wherein the team reaching 500 points wins the game.

Numerous benefits and advantages of this invention will become apparent to those skilled in the art to which it pertains upon reading and understanding of the following detailed specification.

To the accomplishment of the foregoing and related ends, certain illustrative aspects of the disclosed innovation are described herein in connection with the following description and the annexed drawings. These aspects are indicative, however, of but a few of the various ways in which the principles disclosed herein can be employed and are intended to include all such aspects and their equivalents. Other advantages and novel features will become apparent from the following detailed description when considered in conjunction with the drawings.

### BRIEF DESCRIPTION OF THE DRAWINGS

The description refers to provided drawings in which similar reference characters refer to similar parts throughout the different views, and in which:

FIG. 1 illustrates a perspective view of one potential embodiment of the Bible charade game system of the present invention in accordance with the disclosed architecture;

FIG. 2 illustrates a perspective view of exemplary masks in accordance with the disclosed architecture; and

FIG. 3 illustrates a perspective view of exemplary playing or life lesson card in accordance with the disclosed architecture.

### DETAILED DESCRIPTION OF THE PRESENT INVENTION

The innovation is now described with reference to the drawings, wherein like reference numerals are used to refer to like elements throughout. In the following description, for purposes of explanation, numerous specific details are set forth in order to provide a thorough understanding thereof. It may be evident, however, that the innovation can be practiced without these specific details. In other instances, well-known structures and devices are shown in block diagram form in order to facilitate a description thereof. Various embodiments are discussed hereinafter. It should be noted that the figures are described only to facilitate the description of the embodiments. They are not intended as an exhaustive description of the invention and do not limit the scope of the invention. Additionally, an illustrated embodiment need not have all the aspects or advantages shown. Thus, in other embodiments, any of the features described herein from different embodiments may be combined.

As noted above, there is a long-felt need in the art for a unique game that helps in improving knowledge about the Bible and scripture. There is also a long-felt need in the art for a game system that allows players to answer questions or act out scripture and lessons to play a game and learn about the Bible. Additionally, there is a long-felt need in the art for a game system that is designed to provide fun, while testing one's knowledge of the Bible and learning as the game is played. Moreover, there is a long-felt need in the art for a game that is designed to be and interactive multi-player game which includes scripture cards, playing chips, timer, instruction card(s), and more. Further, there is a long-felt need in the art for a game that includes a software application for teaching about Bible scripture and lessons. Furthermore, there is a long-felt need in the art for a Bible game that allows individuals to play a variety of games to learn about the Bible. Finally, there is a long-felt need in the art for a unique charades-based game involving Bible scripture and lessons that offers a way for individuals to have fun with friends and family while still being educated on the Bible.

The present invention, in one exemplary embodiment, is a method of playing a Bible game for learning life lessons of the Bible. The method includes the steps of providing a plurality of playing cards; providing a plurality of masks; providing a plurality of red chips; providing a plurality of black chips; providing a plurality of yellow chips; providing a sand timer; providing learning books; mixing the playing cards and placing them face down during play; picking up two cards by a player and turning said cards over; collecting the cards by the player if the card matches or else placing the cards facing down again in their original position; and, continuing game play by having another player pick up two cards.

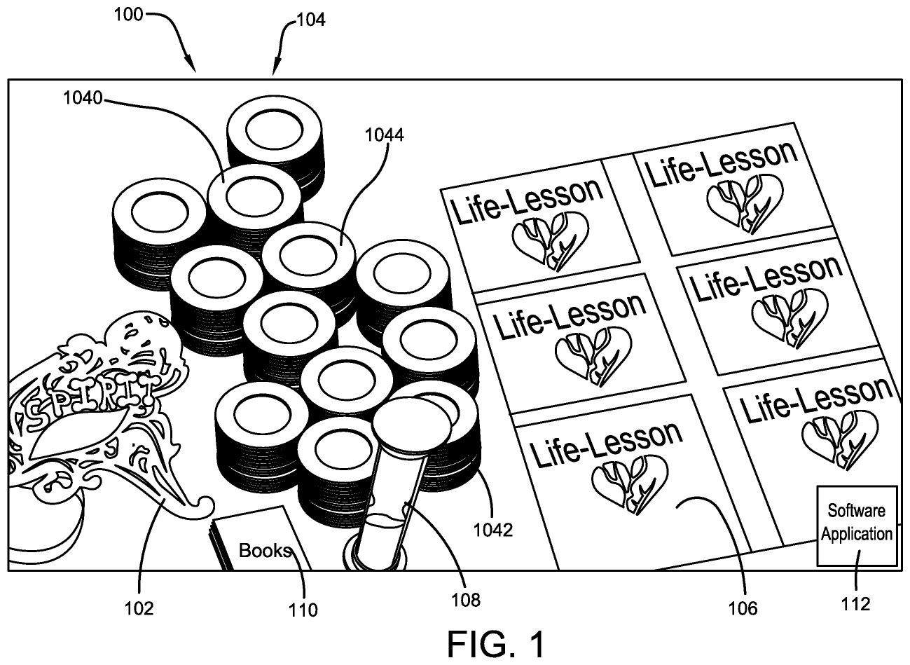

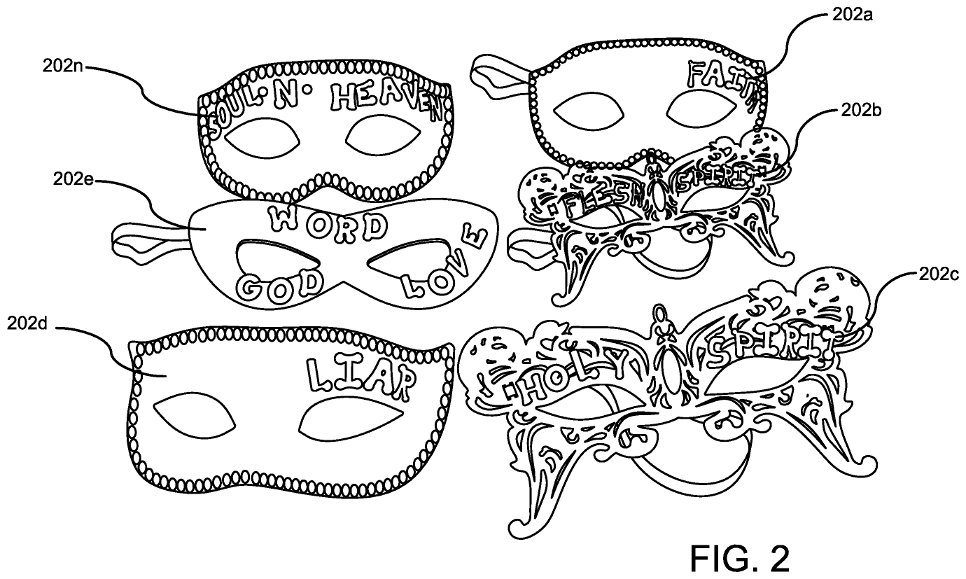

Referring initially to the drawings, FIG. 1 illustrates a perspective view of one potential embodiment of the Bible charade game system of the present invention in accordance with the disclosed architecture. The Bible charade game system 100 of the present invention is a unique, charades-based game involving Bible scripture and lessons, wherein said scripture and lessons can be acted out with alternate endings. More specifically, the game includes a plurality of (i.e., twenty) masks 102, a plurality of red, black, and yellow chips 104, a plurality of (i.e., three hundred) life lesson cards 106, a sand timer (i.e., one minute) 108, and a plurality of (i.e., four) evangelist books 110. The twenty masks 102 may include a Holy Spirit mask, a Charity Mask, a Faith Mask, a Believer Mask, a Follower Mask, and more (collectively shown as 202a-n in FIG. 2).

In some embodiments, the red chips 1040 are used as an indicator of a winner of a round played using the Bible charade game system 100. A user with the most red chips 1040 at the end of the game is declared as winner of the game. Yellow chips 1042 are used for earning extra playing time and black chips 1044 are provided to a user when questions asked by other users playing the game are answered correctly. The sand timer 108 is used for counting, for example, one-minute durations for a player/team to give a correct answer to a question and if a team/player provides an incorrect answer within a minute, then, the next team/player draws a new card and the cards are drawn until the minute has been exhausted.

The game system 100 allows users to play a variety of games using some or all components of the system 100. Different versions of games played using the system 100 are used for learning different aspects of the Bible. Further, the games can be played by individual players or by teams. Various games can be played by two to ten players. A host navigates the games and when a plurality of teams play the games, then, a spokesperson can be designated by each team. The spokesperson is the official leader of the team and can give answers on behalf of the team.

The cards can have scrambled words and Bible learnings/teachings printed thereon and multiple cards can have the same or similar information. The cards are picked by players for playing the game as described in various games later in the disclosure. The cards can be made of plastic and can be in different shapes and designs. The top surface of all the cards is the same, thereby, removing biases from the game while choosing a card by a player. It should be noted that some cards may be notated with a definitive red, yellow, or black line on the bottom surface of the card for identifying the chips that can be given when such cards are collected by a player.

As described earlier, the yellow chips are used for buying extra time, therefore, in some embodiments, a plurality of multiple-choice questions come with extra yellow chips for earning bonus time. Masks 102 can be worn by individuals while playing the games and can be based on the Bible lessons they learn while playing a game.

A software application 112 can be used for teaching individuals about the scripture and lessons. The software application 112 can display the scripture and lesson learned during a game and a host of the game can enter the scripture.

The disclosure hereinbelow describes various exemplary games which can be played using the game system.

A first exemplary Game 1 (All queens and princesses named in the Bible) is described as follows: the first game is a mix and match game for learning about all the queens and princesses in the Bible. The game is played using an answer key book and sixty cards. The objective of the mix and match game is to have the most matched cards to win the game. The winner of the game can also be provided various gifts for winning the game. For playing the mix and match game, the 60 cards are shuffled and are placed face down. Each card has a queen, or a princess name written on the face down surface. A first player (chosen or agreed upon by players playing the game) choses any two cards and flips them to view the queen or princess name. If both the cards are matched and have a same queen or princess name, then, the cards are collected by the player. In cases where the two cards picked up by the first player do not match, then, the cards are placed in their original position face down. Then, the next player picks up two cards in a similar manner and keeps them if the cards are matched, otherwise the cards are placed face down and the game is moved forward. At the end, when all the cards are picked up, the player with the highest number of matched cards (i.e., matching pairs) wins the game. The answer key book can be used for checking the queen or princess name and can also be used for noting the number of cards won by players.

A second exemplary Game 2 (All Jesus titles and names in the Bible) is described as follows: the second game is a mix and match game for learning about all Jesus titles and names in the Bible. The game is played using an answer key book and 56 cards. The objective of the mix and match game is to have the most matched cards (i.e., matched pairs) to win the game. The winner of the game can also be provided various gifts for winning the game. For playing the mix and match game, the 56 cards are shuffled, and are placed face down. Each card has a Jesus title or name written on the face down surface. A first player (chosen or agreed upon by players playing the game) choses any two cards and flips them to view the Jesus title or name. If both the cards are matched and have the same title or name, then, the cards are collected by the player. In cases where the two cards picked up by the first player do not match, then, the cards are placed in their original position face down. Then, the next player picks up two cards in a similar manner and keeps them if the cards are matched, otherwise the cards are placed face down and the game is moved forward. At the end, when all the cards are picked up, the player with the highest number of matched cards (i.e., matched pairs) wins the game. The answer key book can be used for checking the Jesus title or name and can also be used for noting the number of cards won by players.

A third exemplary Game 3 (All Lucifer titles and names in the Bible) is described as follows: the third game is a mix and match game for learning about all Lucifer titles and names in the Bible. The game is played using an answer key book and 60 cards. The objective of the mix and match game is to have the most matched cards (i.e., matched pairs) to win the game. The winner of the game can also be provided various gifts for winning the game. For playing the mix and match game, the 60 cards are shuffled, and are placed face down. Each card has a Lucifer title or name written on the face down surface. A first player (chosen or agreed upon by players playing the game) choses any two cards and flips them over to view the Lucifer title or name. If both the cards are matched and have the same Lucifer title or name, then, the cards are collected by the player. In cases where the two cards picked up by the first player do not match, then, the cards are placed in their original position face down. Then, the next player picks up two cards in a similar manner and keeps them if the cards are matched, otherwise the cards are placed face down again and the game is moved forward. At the end, when all the cards are picked up, the player with the highest number of matched cards, or matched pairs, wins the game. The answer key book can be used for checking the Jesus title or name and can also be used for noting the number of cards won by players.

A fourth exemplary Game 4 (Name it Claim it all God Promises) is described as follows: this game is played using a magnet board, 80 magnet pellets, four dry erase markers, an answer key, one sand timer, 300 cards, a score board, one book of sticky paper starts, 50 black chips, 50 red chips, and 50 yellow chips. A player reaching 500 points wins the game 4.

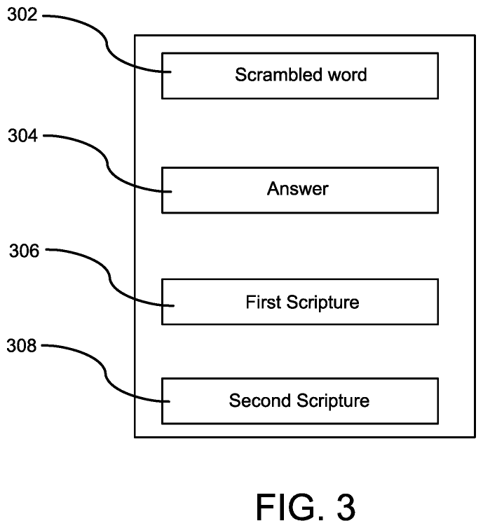

A method of playing Game 4 is as follows: a host facilitates and navigates the game. Specifically, the host keeps the time, holds all the cards, and holds the chips. Four or less players can play the game as individuals, while six or more players can be split into two teams for playing the game. Each team is provided individual score cards and a player from each team can keep the score using the score card. Each card has a scrambled word 302, an answer 304, and a pair of clues 306, 308 in the form of a scripture printed thereon as shown in FIG. 3. Initially, for playing the game, the host picks up a card and calls out each letter to be placed on the score cards by the teams and simultaneously turns over the sand timer for counting the elapsed time. Each team/individual member is required to unscramble the word within a time limit defined by the sand timer.

Each individual player or a team gets a black chip equivalent to 50 points when the word is unscrambled correctly within the time limit defined by the sand timer. In cases where both the team/all the individual players are unable to unscramble the scrambled word, then, the host can be asked to give a clue. Thereafter, the host reads the scripture, and the teams get a yellow chip equivalent to 25 points upon successfully unscrambling the word. In cases where the teams are unable to unscramble the word, even after the first clue, then, the host reads a second clue and the teams get a red chip equivalent to 15 points upon successfully unscrambling the word. The first team/individual player to reach 500 points wins the game. It should be noted that the clues are God's promises and are also learned by players while enjoying and playing the game.

A fifth exemplary Game 5 (Character of the Holy Spirit) is described as follows: a Game 5 is a mix and match game and can be played using an answer key, 58 cards, and an instruction paper. A player having the most matched cards or pairs at the end of the game is designated the winner of the game. In the present game, players can also earn extra points by calling out cards correctly as a fruit or a gift of the Holy Spirit. For playing the game, a first player picks up two face down cards and turns them over. The picked-up cards are called out as a fruit or as a gift of the Holy Spirit by the first player. If the picked-up cards are matched and if the cards are called a fruit or a gift of the Holy Spirit, then, the player is given points, otherwise the cards are placed face down again in their original position. The game is played by players successively picking up two cards and calling them out correctly.

A sixth exemplary Game 6 (All the Kings and Prophets of the New and Old Testament in Bible) is described as follows: a Game 6 is a mix and match game and played using an answer key, 128 cards, and an instruction paper. A player with the maximum number of matched cards or pairs is declared as the winner. Players can win extra points by correctly calling out if the card which is turned over is a bad or a good king. For game playing, cards are mixed by shuffling and then are placed face down. A first player turns two cards over and calls out a good king or a bad king. The player collects the cards if the cards are matched (i.e., paired), otherwise the cards are flipped back to their original position. In a similar manner, the players, in turn, pick up the cards and call out a good king or a bad king.

Certain terms are used throughout the following description and claims to refer to particular features or components. As one skilled in the art will appreciate, different persons may refer to the same feature or component by different names. This document does not intend to distinguish between components or features that differ in name but not structure or function. As used herein “charade-based Bible game system”, “Bible game system”, “game system”, and “system” are interchangeable and refer to the charade-based Bible game system 100 of the present invention.

Notwithstanding the foregoing, the charade-based Bible game system 100 of the present invention can be of any suitable size and configuration as is known in the art without affecting the overall concept of the invention, provided that it accomplishes the above-stated objectives. One of ordinary skill in the art will appreciate that the charade-based Bible game system 100 as shown in the FIGS. are for illustrative purposes only, and that many other sizes and shapes of the charade-based Bible game system 100 are well within the scope of the present disclosure. Although the dimensions of the charade-based Bible game system 100 are important design parameters for user convenience, the charade-based Bible game system 100 may be of any size that ensures optimal performance during use and/or that suits the user's needs and/or preferences.

Various modifications and additions can be made to the exemplary embodiments discussed without departing from the scope of the present invention. While the embodiments described above refer to particular features, the scope of this invention also includes embodiments having different combinations of features and embodiments that do not include all of the described features. Accordingly, the scope of the present invention is intended to embrace all such alternatives, modifications, and variations as fall within the scope of the claims, together with all equivalents thereof.

What has been described above includes examples of the claimed subject matter. It is, of course, not possible to describe every conceivable combination of components or methodologies for purposes of describing the claimed subject matter, but one of ordinary skill in the art may recognize that many further combinations and permutations of the claimed subject matter are possible. Accordingly, the claimed subject matter is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A method of playing a Bible game, the method comprising the steps of:
providing a plurality of playing cards wherein each said playing card having a common top surface and a Bible name selected from a group of Bible names printed on a bottom surface;
mixing said playing cards;
placing said playing cards face down during play;
picking up a first pair of said playing cards by a first player;
turning said first pair of said playing cards over;
collecting said first pair of said playing cards by said first player if said first pair of said playing cards are a match;
replacing said first pair of said playing cards face down if said first pair of said playing cards are not a match;
continuing game play by having a second player picking up a second pair of said playing cards;
turning said second pair of said playing cards over;
collecting said second pair of said playing cards by said second player if said second pair of said playing cards are a match;
replacing said second pair of said playing cards face down if said second pair of said playing cards are not a match;
continuing said picking, said turning, said collecting, and said replacing of said playing cards until all said playing cards are collected; and
declaring a winner based on which player holds the most matched pairs of said playing cards.

2. The method of playing a Bible game of claim 1, wherein said group of Bible names selected from a group consisting of Bible Queens, Bible Princesses, Bible Jesus titles, and Bible Lucifer titles.

3. The method of playing a Bible game of claim 2 further comprising a step of providing an answer key book for referencing said group of Bible names.

4. The method of playing a Bible game of claim 1, wherein said group of Bible names are Holy Spirit characters.

5. The method of playing a Bible game of claim 4, wherein said Holy Spirit characters having a fruit name or a gift name.

6. The method of playing a Bible game of claim 5 further comprising a step of calling out said fruit name or said gift name prior to said picking up said first pair of said playing cards by said first player.

7. The method of playing a Bible game of claim 6 further comprising a step of earning extra points by correctly said calling out of said fruit name or said gift name.

8. The method of playing a Bible game of claim 1, wherein said group of Bible names are Kings and Prophets of the New Testament Bible or Old Testament Bible.

9. The method of playing a Bible game of claim 8 further comprising a step of designating said Kings and said Prophets as good or bad.

10. The method of playing a Bible game of claim 9 further comprising a step of calling out said Kings and said Prophets as said good or said bad.

11. The method of playing a Bible game of claim 10 further comprising a step of earning extra points by correctly said calling out said Kings and said Prophets as said good or said bad.

12. A method of playing a Bible game, the method comprising the steps of:
providing a plurality of playing cards wherein each said playing card having a common top surface and a Bible name selected from a group of Bible names printed on a bottom surface;
mixing said playing cards;
placing said playing cards face down during play;
picking up a first pair of said playing cards by a first player;
turning said first pair of said playing cards over;
collecting said first pair of said playing cards by said first player if said first pair of said playing cards are a match;
replacing said first pair of said playing cards face down if said first pair of said playing cards are not a match;
continuing game play by having a second player picking up a second pair of said playing cards;
turning said second pair of said playing cards over;
collecting said second pair of said playing cards by said second player if said second pair of said playing cards are a match;
replacing said second pair of said playing cards face down if said second pair of said playing cards are not a match;
continuing said picking, said turning, said collecting, and said replacing of said playing cards until all said playing cards are collected;
declaring a winner based on which player holds the most matched pairs of said playing cards; and
further wherein said group of Bible names selected from a group consisting of Bible Queens, Bible Princesses, Bible Jesus titles, Bible Lucifer titles, Holy Spirit characters, Kings and Prophets of the New Testament Bible or Old Testament Bible.

13. A method of playing a Bible game, the method comprising the steps of:
providing a plurality of life lesson cards each having a scrambled Bible word and an unscrambled answer to said scrambled Bible word;
providing a timer;
picking up said life lesson card by a host;
reading letters of said scrambled Bible word to a player;
starting said timer;
unscrambling said scrambled Bible word by said player;
determining if said unscrambling of said scrambled Bible word completed within a timer limit; and
awarding a first award to said player if said scrambled Bible word unscrambled within said timer limit.

14. The method of playing a Bible game of claim 13, wherein said life lesson cards having a pair of clues including a first scripture and a second scripture for assisting said player with unscrambling said scrambled Bible word.

15. The method of playing a Bible game of claim 14 further comprising a step of providing a plurality of chips, wherein said plurality of chips having three groups of chips selected from a first group of red chips, a second group of yellow chips, and a third group of black chips, and further wherein said awarding of said first award includes providing one chip from one of said three groups of chips to said player.

16. The method of playing a Bible game of claim 15, further comprising the steps of:
reading said first scripture to said player; and
awarding a second award including providing one chip from another of said three groups of chips to said player.

17. The method of playing a Bible game of claim 16 further comprising the steps of:
reading said second scripture to said player; and
awarding a third award including providing one chip from yet another of said three groups of chips to said player.

18. The method of playing a Bible game of claim 14 further comprising a step of providing a plurality of masks, wherein each player wears a different mask selected from a group consisting of a Holy Spirit mask, a Charity Mask, a Faith Mask, a Believer Mask, and a Follower Mask.

19. The method of playing a Bible game of claim 14, wherein said timer is a sand timer.

20. The method of playing a Bible game of claim 19, wherein said timer limit is one minute.
